(19) United States
(12) Patent Application Publication
(10) Pub. No.: US 2005/0285313 A1
(43) Pub. Date: Dec. 29, 2005

(54) Gel/cure unit

(76) Inventor: Phillip Dean Ward, Pittsburg, KS (US)

Correspondence Address: SHOOK, HARDY & BACON LLP, 2555 GRAND BLVD, KANSAS CITY,, MO, 64108, US

(21) Appl. No.: 11/159,802

(22) Filed: Jun. 23, 2005

Related U.S. Application Data
(60) Provisional application No. 60/582,169, filed on Jun. 24, 2004.

(51) Int. Cl. B29C 71/00

(52) U.S. Cl. 264/492; 425/174.4; 425/445

(57) ABSTRACT

Described is a gel/cure unit which utilizes separate temperature-control zones. Each zone includes a plurality of quartz infrared lamps which administer heat to a coated substrate which passes through the unit on rollers. One infrared sensor is provided in each zone to remotely detect the temperature surface of the coated substrate. Each zone also has a temperature controller, into which a zone temperature setting may be made. If the zone temperature reading is lower than the zone temperature setting, the intensity of the infrared lamps is increased until that zone meets the set temperature. If the reading is higher, the temperature is decreased until the set temperature is reached. An air-control system for the unit is also disclosed. The air is introduced from top to bottom through the unit. This is done using a pair of induction blowers located on top of the unit and an exhaust blower which is located at the bottom of the unit.

### CROSS-REFERENCE TO RELATED APPLICATIONS

This application claims the benefit of U.S. Provisional Application No. 60/582,169 filed Jun. 24, 2004 under the same title and having the same named inventor.

### STATEMENT REGARDING FEDERALLY SPONSORED RESEARCH OR DEVELOPMENT

None.

### BACKGROUND OF THE INVENTION

1. Field of the Invention

The present invention relates to the field of curing or gelling coatings such as photopolymers, inks, adhesives, and other substances which are deposited onto items such as paper, cloth, a plaques, tiles, plates, articles of clothing, as well as other kinds of substrates.

2. Description of the Related Art

One conventional means to cure or gel substances onto substrates involves passing the item on a conveyor through a oven. It is known to use light sources (e.g., ultraviolet mercury lamps) or electric heaters (e.g., infrared or resistance heaters) as a heat source for this purpose. It is also known to use blower arrangements which recirculate air over the article for cooling or other purposes. These conventional devices, however, have their drawbacks.

For one, these conventional devices oftentimes fail to adequately regulate cure temperatures as the substrate passes through the oven on the conveyor. Temperature hot spots created on the substrate (due to i.e., lamp positioning) can hinder the cure process and damage heat sensitive substrate materials.

Vapor barriers are another disadvantage. During the cure process, the ink coatings used will release chemical vapors. If these fumes are allowed to linger over the substrate, they will interfere with the cure process which requires exposure to fresh unsaturated air.

Therefore, there is a need in the art for a device which provides better temperature control and efficiently removes the fumes created by the heating of the coating.

### SUMMARY OF THE INVENTION

The present invention provides a gel/cure unit. The unit has at least one zone including at least one infrared lamp. The lamp administers heat to a coated substrate which passes through the unit on rollers. An infrared sensor is provided in the zone to remotely detect the surface temperature of the coated substrate. The zone also has a temperature control system which may be set to a particular temperature. If the zone temperature reading is lower than the zone temperature setting, the intensity of the at least one infrared lamp is increased until that zone meets the set temperature. If the reading is higher, the intensity is decreased until the set temperature is reached.

An air-control system for the unit is also provided. The air is forced from top to bottom through the unit and is not recycled. This is done using a pair of induction blowers located on top of the unit, passing the air though a plate having uniformly-spaced holes, and then removing the air using an exhaust blower which is located at the bottom of the unit.

### BRIEF DESCRIPTION OF THE DRAWINGS

FIG. 1 is a perspective view of the gel cure unit of the present invention. A broken out section has been taken at the upper front corner to expose the lamps and some other internals of the present invention.

FIG. 2 is a right-side view of the gel cure unit with a breakout section showing a cross-sectional view of some internals of the device.

FIG. 3 is a view of section 2-2 taken out of FIG. 2 and viewed from above.

FIG. 4 is a cross-sectional view of the gel cure unit taken from the front showing the internals of the device.

FIG. 5 is a schematic showing the components used in the temperature control system.

FIG. 6 is a flow diagram showing the processes performed by the temperature control system of the present invention.

### DETAILED DESCRIPTION OF THE INVENTION

The present invention is able to overcome deficiencies existent in the prior art devices and methods by presenting a gel-cure unit having novel air and temperature control systems, as well as other novel features.

The temperature control system of the present invention includes a plurality of fast-response quartz infrared lamps. These lamps are arranged above and transverse to the direction of the coated substrate, e.g., a web, through the device. Also included are two infrared temperature sensors. These infrared sensors take temperature readings directly from the upper surface of the substrate on which the coating exists. Using a temperature controller the system variably manipulates power delivered to the lamps based on the temperatures sensed by the infrared sensors.

The overall unit, in the preferred embodiment, is broken into two zones. A first zone exists in the part of the unit in which the coated substrate is passed into the unit (over a plurality of rollers) for treatment. While passing through the first zone, the substrate passes underneath 12 quartz lamps which are independently controlled. The lamps in the first zone are controlled using a control system. This system comprises an infrared temperature sensor, a temperature controller, and a silicone-controlled relay (SCR). The sensor continually takes readings from the coated substrates surface. Infrared sensors are able to take readings remotely. Thus there is no need to make contact with the substrate surface to obtain a reading. Once a reading is taken, the temperature controller determines whether the temperature falls within a predetermined desired range—which is adaptable for different cure/gel requirements. If the temperature is too low, the controller causes the SCR to increase the power delivered to the 12 lamps in the first zone to raise temperatures in that zone. If the temperature is too high, the power delivered to these lamps will be decreased to cool the zone off. Even though SCR's are used in the preferred embodiment, it is also possible that other kinds of power control relays or other kinds of electrical devices could be used to accomplish the same functional objectives and still fall within the scope of the present invention.

Duplicate systems and processes are used to regulate temperatures as the substrate passes over the rollers through a second zone which, in the preferred embodiment, extends from the first zone to the opening from which the substrate exits the unit. This second zone also has it's own 12 quartz lamps, infrared temperature sensor, temperature controller, and SCR. These features separately control the heat administered in the second zone, but do so in the same fashion temperatures are controlled in the first zone. Temperatures in the second zone may be equalized to those in the first zone, or alternatively, maintained as different because the supporting systems for the two zones are completely physically and functionally independent one from the other.

With respect to the airflow-control system of the present invention, the unit uses dual induction blowers at a top part of the housing to administer air through the unit from top to bottom. An exhaust blower is located in a chamber at the bottom of the unit to simultaneously withdraw the air. None of the air is recirculated. This maximizes the saturation strength of the air making it more available to handle effluent from the coated substrate.

Before the air encounters the treatment chamber, the air passes through a plate with evenly-distributed holes. These holes cause the air to be evenly distributed to the substrate. The resulting flow causes substrate temperatures to be evened out and enables a quicker, more efficient curing operation.

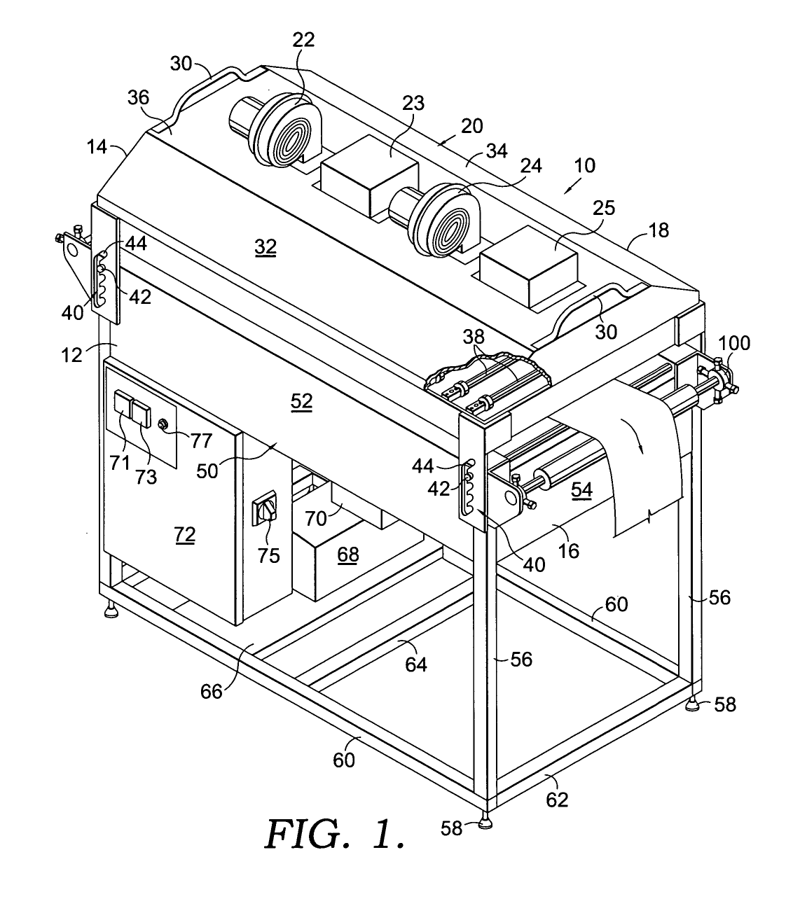

The details of the unit may be seen in FIGS. 1-4. Referring first to FIG. 1, it may be seen that the unit includes a housing 10 which has a front side 12, a left side 14, a right side 16, and a back side 18.

A lid assembly 20 is shown which comprises numerous parts. It should first be recognized that the direction of the coated substrate (e.g., web) through the unit is from left to right (the substrate passes from side 14 to side 16). Disposed atop lid assembly 20 are a first induction blower 22 and a second induction blower 24. These kinds of blowers are readily commercially available and will be known to one skilled in the art as an off the shelf item. The arrangement of blowers 22 and 24 here, however, is unique in that they have been located such that they will create a top to bottom flow pattern throughout the unit.

In addition to blowers 22 and 24, lid assembly 20 also includes a first infrared sensor 26 which is included in a housing 23 and a second infrared sensor 28 which is included in a housing 25. These kinds of infrared sensors are also an off the shelf item which have conventionally been used for other purposes. Here, however, they will be used for temperature measurement during the cure/gel process in the unit.

Infrared detectors like sensors 26 and 28 detect electromagnetic waves which fall between the visible portion of the spectrum and radio waves. Detection of infrared emissions from an object enable these sensors to make a temperature determination by remotely focusing on a portion of that object and detecting the temperatures on that object's surface without making physical contact.

It has been discovered that these abilities make infrared sensors ideal for uses in the unit of the present invention. This is because it is highly impractical in the heat treatment of coatings, e.g., inks, adhesives, to make any contact with the substrate as it passes through the unit on the rollers. To do so might damage the coatings integrity appearance. And the necessary mechanical support required would be extensive. These considerations make the use of contact-requiring sensors, e.g., thermocouples, unacceptable. The use of non-contact infrared sensors avoids these impracticalities.

A pair of handles 30 are provided on the top of lid 20, one at each end. These handles may be used to lift or lower lid 20 relative to a bottom portion 50. Lid assembly 20 is configured with a first sloped portion 32 and a second sloped portion 34. Sloped portions 32 and 34 each lead up to a plateau 36 which is the portion of lid 20 on which each of blowers 22 and 24 and infrared detector housings 23 and 25 are disposed.

Further details regarding the device may be seen in FIGS. 24. From these figures, it may be seen that the unit includes a plurality of fast-response quartz-infrared lamps 38. In the disclosed embodiment, these lamps comprise clear quartz tube heater lamps which include multiwound elements, internal reflectors, ceramic endcaps, and straight flag terminals with oval mounting holes. Suitable lamps are available from Solar Products, Inc. in Pompton Lakes, N.J., U.S.A. Lamps 38 are located above and transverse to the direction of the movement of the web (identified as 92 in the figures) and are located directly beneath a plate 35. Plate 35 has a plurality of evenly-spaced air holes 33. The holes 33 cause the airflow to be evenly dispersed through the unit so that the air reaches different portions of the substrate evenly. This prevents hotspots, and also normalizes air exposure to make the overall process more effective.

The bottom of plate 35 in the preferred embodiment is reflective. This reflectivity maximizes the heating efficiency of the unit because it directs most of the heat downward towards the location of the substrate. The reflective nature of the underside of this plate may be inherent in structures selected (e.g. stainless steel) but could also be created on a nonreflective plate using some form of reflective coating or tape.

As may be seen in FIG. 3, quartz infrared lamps 38 are received in a plurality of sockets 39. These features are necessary to drive each quartz infrared lamp.

Lid assembly 20 may be raised or lowered relative to the bottom of the unit using handles 30 in conjunction with a collaboration of four lid level controlling angled reinforced corners 40. Corners 40 work using a plurality of reciprocating pins 42 which are fixed on the outsides of the bottom portion of the unit. Pins 42 are received in any one of a plurality of angled notches 44 which are defined in each of the reinforced corners 40. The operation of these corners may best be seen in FIG. 1, where it should be understood that to raise the lid 20, the user would simply lift the lid up using handles 30 and pull up on the lid thus drawing pin 42 out of the particular notch and disposing it in a lower notch to create more intermediate distance between lid 20 and the bottom 50. Lid 20 can be lowered using a similar process in which the lid is temporarily lifted and then corner 40 is slid down so that pin 42 is engaged in one of the upper notches. Raising and lowering of lid 20 may be necessary for accommodating substrates of different thicknesses/heights. It also may be necessary in order to meet specific cure requirements in which the intermediate distance between lamps 38 and the substrate might be necessary.

A bottom portion 50 of unit 10 also includes numerous components. Bottom portion 50 has a front panel 52, a right panel 54, and back and left and rear panels (not shown in FIG. 1). The bottom portion is supported on four legs 56 each of which has feet 58 below it upon which the entire apparatus rests. The device is horizontally supported on two longitudinal members 60 which are each connected at their ends by a pair of cross members 62. A transverse member 64 provides further crosswise reinforcement to the frame. Also provided is a platform 66. Platform 66 is used to support an uninterruptible power supply (UPS) 68. UPS 68 provides battery backup to the fan in the case there is a failure in the commercial power grid. This is necessary so that the fans will remain operational in power failure. Thus, air circulation will be maintained to prevent damage to the substrate and other equipment.

Suspended beneath the lower portion of the frame is an exhaust blower 70, which, as already discussed above forcibly removes all the air from the inside of the unit that is being introduced by blowers 22 and 24 creating a top-to-bottom airflow. Thus, all of the air presented to the substrate is fresh. The closed-circuit conventional systems use the air over and over again. This recycled air is already saturated with fumes received from the ink, epoxy, adhesive, or other coating on the substrate. This makes the air less fume absorbent. This hampers the cure/gel process.

Fixed to one of the legs is a control cabinet 72. Control cabinet 72 includes temperature controls, relays, and other electrical equipment needed in order to make the unit functional. A knob 75 turns the entire unit on or off. When the switch is in “on” position, induction blowers 22 and 24 in addition to exhaust blower 70 are activated, and the temperature control features of the unit will be operational. An LED indicator 77 will be illuminated with the system is on.

The system's temperature controls include a first temperature controller 71 and a second temperature controller 73 which are shown on the front of the cabinet. Each of controllers 71 and 73 include independent digital display/pushbutton arrangements (not shown specifically in the figures) which a user may use to set a temperature for each zone. Thus, a user is able to set a temperature for the first zone using controller 71. Controller 73 is used to set the temperature for the second zone. One example of a particular temperature controller which might be used to comprise controllers 71 and 73 is manufactured by Partlow, Inc. in Gurnee, Ill., U.S.A. Other controllers, however, could be used as well which would accomplish the objectives of the present invention.

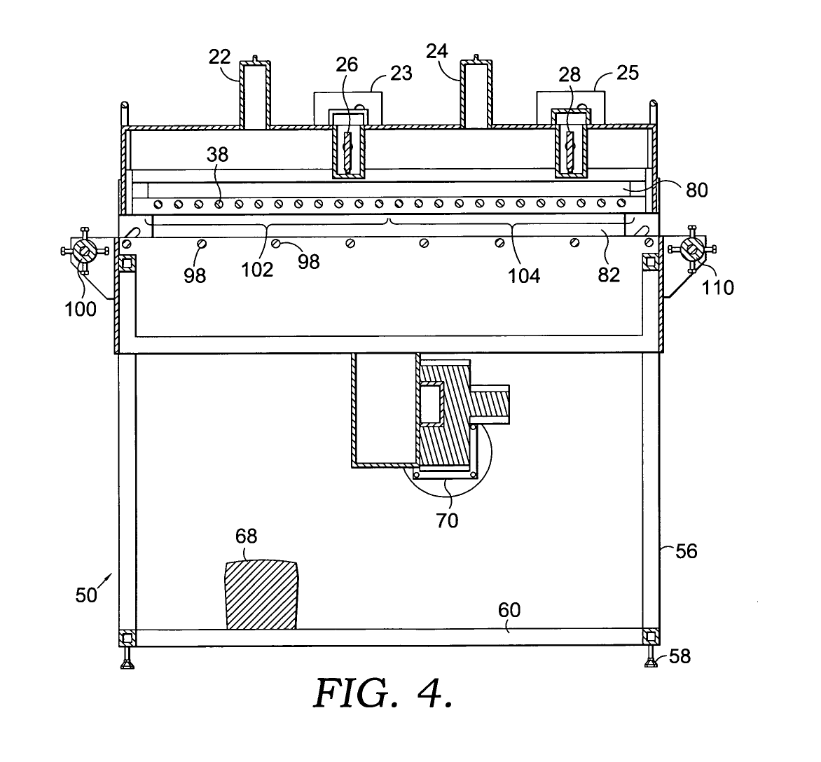

Controllers 71 and 73 are associated and work in conjunction with sensors 26 and 28 respectively. The controllers have inputs for the electronic information received from the sensors. In response to the information received from the sensors, the temperature controllers use SCR relays to increase and decrease the output of the lamps in a first zone 102 (see FIG. 4) and a second zone 104.

As will be described hereinafter, two separate zones of lamps are controlled at the dictates of each of sensors 26 and 28 respectively. Each of temperature control devices 71 and 73 will receive electrical communications from one of the infrared sensors 26 and 28. Using the temperature settings made by the user, the temperature control devices for each zone will maintain the temperatures in each zone using the sensed temperature information from sensors 26 and 28.

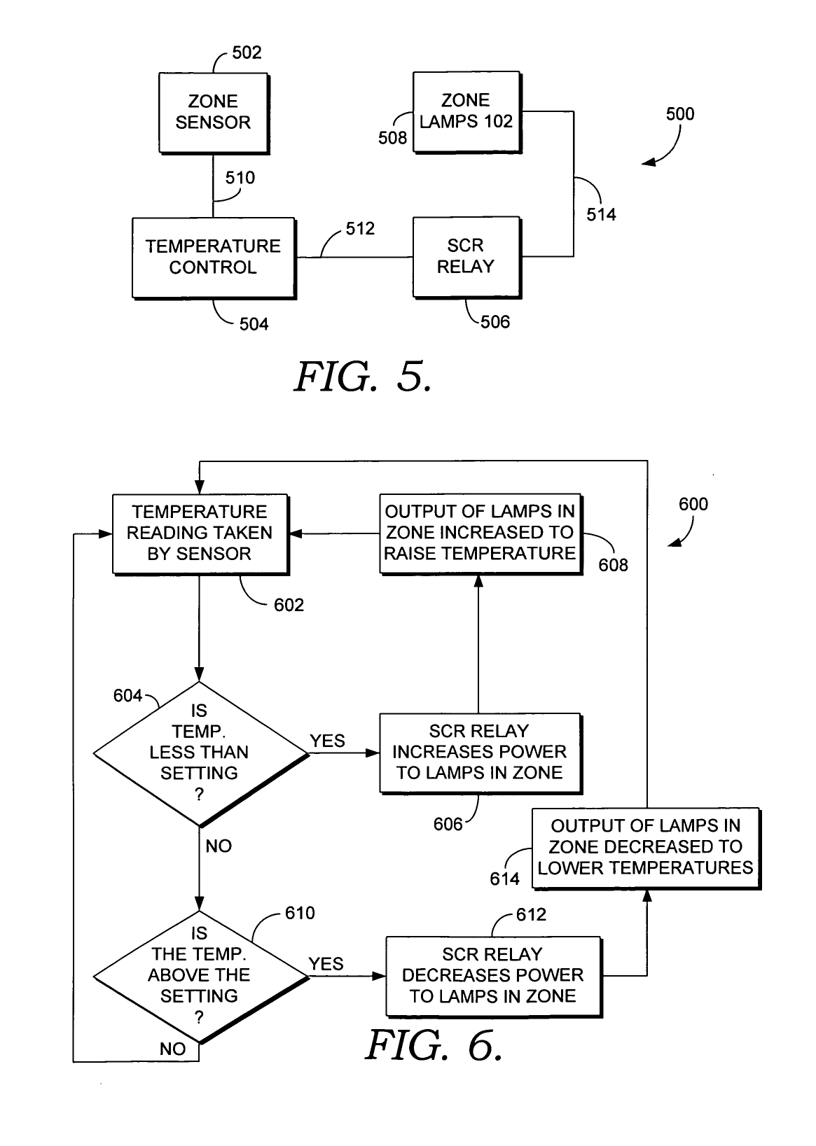

The two zones of the unit have two entirely separate control systems, each of which are identical to the one disclosed in FIG. 5, which will be discussed in detail later. The first zone control system comprises sensor 26, temperature controller 71, a first power control relay (not shown), and first zone lamps 102. The second zone control system comprises sensor 28, temperature controller 73, a second power control relay (not shown), and second zone lamps 104. The sensors are aimed between the lamps so that the lamps do not interfere with obtaining readings from the coated substrate.

With these systems, a temperature reading equal to the temperature selected will prompt no action. But sensing a temperature below the set temperature will prompt the temperature controller to increase the signal to an SCR which is also inside cabinet 72. This increase in signal to the relay will cause it to increase the power to the quartz lamps in the associated zone, and thus control the internal temperatures in that zone in the unit. Similarly, a temperature reading above the setting will cause the controller to decrease the signal to the power control relay. This will result in a power reduction to the lamps which will lower the internal temperatures in the zone.

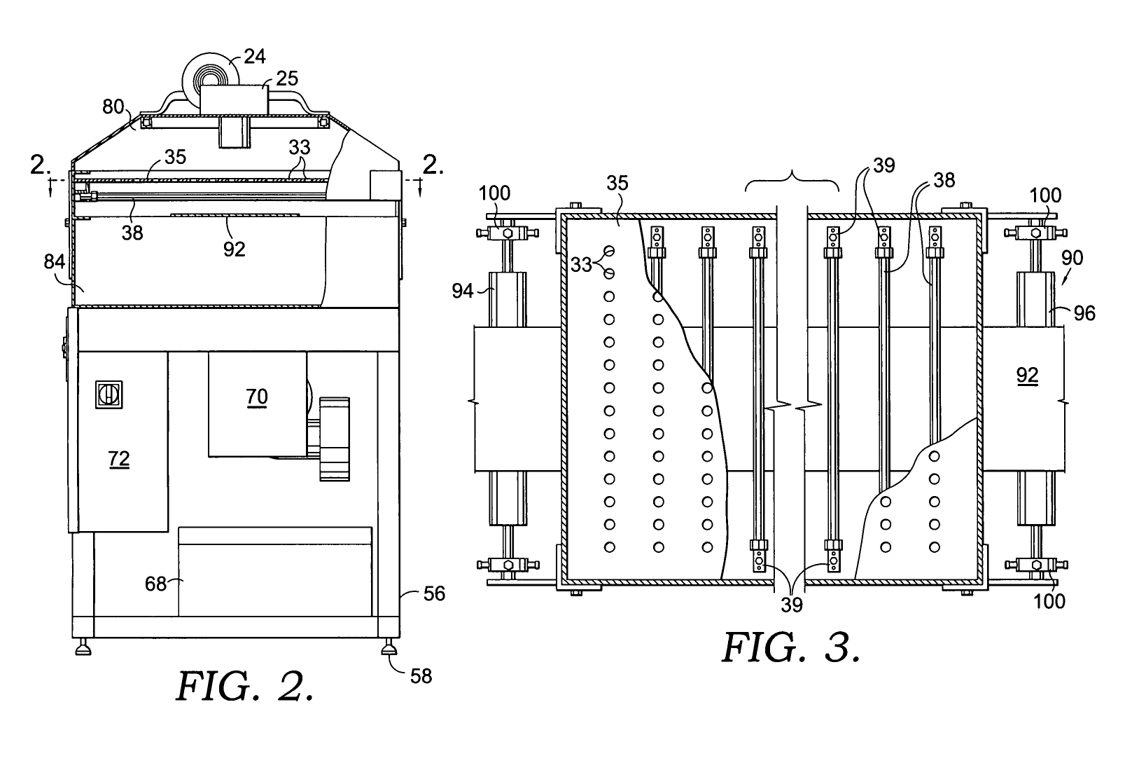

The locations of the two distinct zones of the unit as well as other internal features of the invention may best be seen in FIGS. 2 and 4. Referring to these figures, the internal arrangement includes an upper chamber 80 an intermediate chamber 82 and a lower chamber 84.

Thinking in terms of air circulation, air is introduced by blowers 22 and 24 into upper chamber 80. From there, the air passes through the holes 33 in plate 35. Because of the uniformly spaced holes 33, air is evenly distributed to the substrate being processed. (This can be seen in FIG. 3). Once through these holes, the air is in an intermediate chamber 82 and passes across the lamps 38 and then on and across the substrate. One skilled in the art will recognize that constant airflow to the substrate is an important part of the curing process. Once past the substrate the air will pass into the lower chamber 84 where it will be exhausted by the exhaust blower 70. This arrangement enables the system to accomplish the objective of always introducing fresh air to the substrate. The process of the present invention uses a little more energy than required by recirculation systems, but the benefit to the cure/gel process has been shown to greatly outweigh the disadvantages caused by the added electrical expense.

Seen from above in FIG. 3 and in cross section in FIG. 4 is the roller conveyance system 90 of the present invention. One skilled in the art will recognize that the substrate transmitted through this kind of system is driven by external forces, namely the pulling of the web/substrate through the unit from external devices. It is important, however, that systems be in place to not impede the progress of the web through the unit during the cure process so that the substrate can be exposed for a uniform amount of time. The web 92 can be seen as introduced by way of a first guide roller 94, and leaves the unit on a second guide roller 96. Rollers 94 and 96 can be used to manually align and longitudinally adjust the passage of the substrate through the unit. Manual controls 100 exist which enable the user to manually align rollers 94 and 96 if necessary. The web is supported on the inside of the unit atop a plurality of intermediate support rods 98 which may be seen in FIG. 4. Rollers 94 and 96 roll freely to allow the web to pass through the unit.

How the two-zone concept is used to treat the coated substrate may be seen in FIG. 4. The substrate will enter the unit from the left, first encountering the environment of the first zone inside chamber 80 which is maintained using lamps 102 and sensor 26. After being exposed to the environment in the first zone, the substrate will move on to the environs of the second zone inside chamber 80 which exists at the point the substrate is leaving the unit and is maintained using sensor 28 and lamps 104.

It should be understood that even though only two zones are shown in unit 10 of the present invention, that it is within the scope of the present invention to construct a unit which has multiple zones. For example you could have a five zone unit which operates by the same processes and using similar systems. To the contrary, it is also possible to construct a unit which has only one zone (or in other words is not broken into separate zones at all). This variation would also fall within the scope of the present invention.

In the preferred arrangement, however, the temperatures in each of the zones (either the first zone which includes first group of lamps 102 and is monitored by first sensor 26 or the second zone which includes second group of lamps 104 and which is monitored by second sensor 28) are controlled using a system 500 like the one disclosed in FIG. 5. FIG. 5 reveals that system 500 includes a first infrared sensor 502 (e.g, sensor 26) which is strategically located in the first zone (e.g., the part of the unit containing the first group of lamps 102). A temperature control 504 is electrically connected to and receives a plurality of electronic temperature readings 510 from the sensor. Temperature control 504 is settable to a temperature. If the actual temperature in the zone as read by the sensor 502 is below the set temperature, the signal in line 512 will be increased. If the read temperature is above the set temperature, the signal in line 512 will be decreased. If the temperature is at the set temperature, the signal output by temperature control 504 will remain the same.

Regardless of what the signal in line 512 is, relay 506 will convert it into a reciprocating power output in a line 514. Thus, increased signal in line 512 will result in increased power to one or more lamps 508. This will elevate temperatures in that zone. Similarly, decreased line 512 signals will result in decrease power to the lamps 508 thus lowering temperatures in the zone. Constant signal in line 512 (which is reflective of a temperature reading by sensor 502 which is inside the predetermined range) will result in no change in the power delivered to the lamps thus neither heating or cooling the temperatures in the zone.

Only one system is shown in FIG. 5 for the sake of simplicity, but in the preferred embodiment, two identical systems exist for the purpose of independently controlling the temperatures in the two zones.

Physically, both temperature control 504 and relay 506 are located inside control cabinet 72. For the FIG. 1 embodiment where two such temperature controllers are used, cabinet 72 is shown having two such temperature controllers 71 and 73, each of which is embedded in the face of the cabinet. The two power control relays, though not seen in the figure, would be inside the cabinet and electrically connected to temperature control outputs.

The way in which the FIG. 5 system operates in the environment of the unit disclosed in FIGS. 1-4 is best understood by looking to FIG. 6. FIG. 6 is a process diagram 600 showing a supporting process for the FIG. 5 system, and how that system is used to temperature control the two zones in the unit.

In a first step 602, zone sensor 502 takes a reading. This reading is then transmitted to temperature control 504. Temperature control 504, which already has been set to a particular temperate then determines in a step 604 whether the temperature reading received from sensor 502 is less than the set temperature. If so, then the process moves on to a step 606.

In step 606 temperature control 504 increases the signal to power-control relay 506. The increased signal results in increased power to the lamps which increases the infrared output from the quartz lamps 508 in a step 608. The increased output will raise the temperatures in that specific zone.

After step 608, it may be seen that the process returns to its beginning point in a step 602. Thus, there is a continuous loop made that is repeated until the temperature is raised above the set temperature.

If in step 604 the temperature sensed is greater than the set temperature, the process advances to a step 610 which like step 604, is an inquiry. At step 610 the temperature control 504 determines whether the sensed temperature is above the set temperature.

If so, the process moves to a step 612. In step 612 temperature control 504 decreases the signal to the power-control relay 506. This decrease in signal causes the relay to drop the power administered to the lamps in the zone. The power drop causes the output of the lamps in the zone to be decreased in a step 614, thus lowering temperatures in that particular zone in the unit. Again, like with the loop including steps 606 and 608, this fork of the process also returns to step 602 to complete a loop.

In situations where the temperature is substantially equal to the set temperature, step 610 will direct the process back to the reading step 602. Thus, if the temperature is substantially identical to the set temperature, the process will continually loop between steps 602, 604, 610, and then back to 602 until there is drop which triggers a heat increase in steps 606 and 608 or excessive temperatures which trigger a heat decrease in steps 612 and 614.

It should be noted that the continuous looping of all possible routes in the FIG. 6 processes will occur with extreme rapidity giving the user the impression that temperature deviations are dealt with instantaneously.

It should also be noted that FIG. 6 discloses the process for only one zone. For the two-zone embodiment disclosed in FIGS. 1-4, as well as other multiple-zoned embodiments, identical simultaneous processes would exist for and be ongoing in each of the zones in the unit. This enables temperatures in each of the zones to be controlled independently.

It will be appreciated by persons skilled in the art that the present invention is not limited to what has been particularly shown and described hereinabove. Rather, all matter shown in the accompanying drawings or described hereinabove is to be interpreted as illustrative and not limiting. Accordingly, the scope of the present invention is defined by the appended claims rather than the foregoing description.

1. A unit for heat-treating matter, said matter being deposited on a substrate, said unit comprising:
a first infrared lamp located in a first zone;
a first infrared detection device aimed at a surface of said substrate when said substrate is in said first zone, said first infrared detection device adapted to receive infrared light from said substrate to make a first temperature reading; and
a temperature control system adapted to compare said first temperature reading to a first temperature setting, said temperature control system further adapted to increase the intensity of said first infrared lamp if said first temperature reading is lower than said first temperature setting, said temperature control system further adapted to decrease the intensity of said first infrared lamp if said first temperature reading is higher than said first temperature setting.

2. The unit of claim 1 comprising:
a second infrared lamp located in a second zone;
a second infrared detection device aimed at said substrate when said substrate is in said second zone, said first second infrared detection device adapted to receive infrared light from said substrate to make a second temperature reading; and
said temperature control system adapted to compare said second temperature reading to a second temperature setting, said temperature control system further adapted to increase the intensity of said second infrared lamp if said second temperature reading is lower than said second temperature setting, said temperature control system further adapted to decrease the intensity of said second infrared lamp if said second temperature reading is higher than said second temperature setting.

3. The unit of claim 2 comprising:
a conveying arrangement for supporting said substrate through said unit into said first zone and then into said second zone.

4. The unit of claim 3 wherein said conveying arrangement comprises rollers.

5. The unit of claim 2 wherein said temperature control system comprises:
a first subsystem adapted to maintain the temperature in said first zone; and
a second subsystem adapted to maintain the temperature in said second zone.

6. The unit of claim 5 wherein said first subsystem comprises:
a first temperature controller which is the component of said temperature control system which compares said first temperature reading to a first temperature setting, said first controller further adapted to send a first signal to a first power-control relay, said first power-control relay adapted to increase or decrease power to said first lamp depending on said first signal.

7. The unit of claim 6 wherein said second subsystem comprises:
a second temperature controller which is the component of said temperature control system which compares said second temperature reading to a second temperature setting, said second controller further adapted to send a second signal to a second power-control relay, said second power-control relay adapted to increase or decrease power to said second lamp depending on said second signal.

8. The unit of claim 7 wherein said first and second power-control relays are silicone-controlled relays.

9. The unit of claim 7 wherein said first and second temperature controllers include interfacing equipment which enables the user to input said first and second temperature settings, respectively.

10. The unit of claim 1 wherein said first and second infrared lamps are quartz lamps.

11. The unit of claim 1 comprising:
a first induction blower for forcibly introducing air into said unit; and
an air egress which allows said air to be removed from said unit.

12. The unit of claim 11 wherein said egress comprises an exhaust blower for the purpose of forcibly removing said air from said unit.

13. The unit of claim 12 wherein said first induction blower is located above said substrate in said first zone and said exhaust blower is positioned below said substrate in said unit so that a flow of air occurs from top to bottom.

14. The unit of claim 13 comprising:
a second infrared lamp located in a second zone;
a second infrared detection device aimed at said substrate when said substrate is in said second zone, said first second infrared detection device adapted to receive infrared light from said substrate to make a second temperature reading; and
said temperature control system adapted to compare said second temperature reading to a second temperature setting, said temperature control system further adapted to increase the intensity of said second infrared lamp if said second temperature reading is lower than said second temperature setting, said temperature control system further adapted to decrease the intensity of said second infrared lamp if said second temperature reading is higher than said second temperature setting; and
a second induction blower located above said substrate in said second zone of said unit.

15. The unit of claim 14 wherein said substrate passes underneath said: (i) first blower, (ii) first sensor, (iii) second blower, and (iv) second sensor in succession.

16. A device for treating matter on a substrate with electromagnetic waves, said device comprising:
a conveyance arrangement for supporting the substrate through a chamber in said device;
an electromagnetic wave emitter for exposing said matter on said substrate with electromagnetic waves; and
an air circulation system for exposing said substrate to fresh air and then exhausting said air.

17. The device of claim 16 wherein said air circulation system comprises an induction blower and an exhaust blower.

18. The device of claim 17 wherein said induction blower is located above said chamber and said exhaust blower is located below said chamber to create a top-to-bottom flow direction in said chamber.

19. A method of treating a substance on a substrate, said method comprising:
exposing said substance to an intensity of infrared electromagnetic energy to heat said substance;
exposing said substance to fresh air by flowing said fresh air across said substrate; and
exhausting said air.

20. The method of claim 19 comprising:
remotely reading a surface temperature on a portion of said substrate by detecting the infrared energy emitted by that portion of said substrate;
comparing said read temperature with a temperature setting;
increasing said intensity if said read temperature is below said temperature setting; and
decreasing said intensity if said read temperature is above said temperature setting.
